(19) United States
(12) Patent Application Publication
(10) Pub. No.: US 2026/0188080 A1
(43) Pub. Date: Jul. 2, 2026

(54) INFORMATION PROCESSING APPARATUS AND METHOD, AND PROGRAM

(71) Applicant: FELICA NETWORKS, INC., Tokyo (JP)

(72) Inventors: Motohiro OOHAMA, Tokyo (JP); Ryo SAWAKI, 1410032 (JP)

(21) Appl. No.: 18/868,270

(22) PCT Filed: May 16, 2023
(86) PCT No.: PCT/JP2023/018217

§ 371 Date: Nov. 22, 2024

(30) Foreign Application Priority Data
May 30, 2022 (JP) 2022-087423

(51) Int. Cl. G07F 17/32

(52) U.S. Cl. CPC G07F 17/329; G07F 17/3237

(57) ABSTRACT

The present technology relates to an information processing apparatus and method and a program capable of performing various lotteries.

An information processing apparatus includes a control unit that determines a winning probability of a user on the basis of at least attribute information indicating an attribute of the user registered in advance or posting history information regarding a history of posting of purchase information by the user and that performs lottery processing on the basis of the winning probability. The present technology can be applied to a campaign system.

### TECHNICAL FIELD

The present technology relates to an information processing apparatus and a method and a program, and more particularly, to an information processing apparatus and a method and a program capable of performing various lotteries.

### BACKGROUND ART

Conventionally, there has been proposed a technique for reading information written on a receipt, determining, from the read information, whether application conditions of a campaign are satisfied, and performing lottery processing of a premium or the like (see, for example, Patent Document 1).

For example, in a system described in Patent Document 1, a terminal of a user captures an image of a receipt and transmits receipt information obtained by performing character recognition on the image of the receipt to a server. The server then determines, on the basis of the received receipt information, whether the application conditions of the campaign are satisfied, performs the lottery processing, and transmits a result of the lottery to the terminal.

This makes it possible to conduct a campaign targeting a wide range of stores without printing additional information on receipts.

### CITATION LIST

### Patent Document

Patent Document 1: Japanese Patent Application Laid-Open No. 2014-203312

### SUMMARY OF THE INVENTION

### Problems to be Solved by the Invention

In the technology described above, however, since only information written on a receipt transmitted to a server is used for lottery processing, various lotteries cannot be realized.

The present technology has been made in view of such circumstances, and enables various lotteries to be performed.

### Solutions to Problems

An information processing apparatus according to a first aspect of the present technology includes a control unit that determines a winning probability of a user on the basis of at least attribute information indicating an attribute of the user registered in advance or posting history information regarding a history of posting of purchase information by the user and that performs lottery processing on the basis of the winning probability.

An information processing method or a program according to the first aspect of the present technology includes a step of determining a winning probability of a user on the basis of at least attribute information indicating an attribute of the user registered in advance or posting history information regarding a history of posting of purchase information by the user and performing lottery processing on the basis of the winning probability.

In the first aspect of the present technology, a winning probability of a user is determined on the basis of at least attribute information indicating an attribute of the user registered in advance or posting history information regarding a history of posting of purchase information by the user, and lottery processing is performed on the basis of the winning probability.

### BRIEF DESCRIPTION OF DRAWINGS

FIG. 1 is a diagram illustrating a configuration example of a campaign system.

FIG. 2 is a diagram illustrating a configuration example of a server.

FIG. 3 is a diagram illustrating a configuration example of a terminal apparatus.

FIG. 4 is a diagram for explaining member registration.

FIG. 5 is a flowchart for explaining a process for requesting member registration and a process for registering a member.

FIG. 6 is a diagram for explaining posting of receipt information and a lottery.

FIG. 7 is another diagram for explaining the posting of receipt information and the lottery.

FIG. 8 is a flowchart for explaining a process for participating in a campaign.

FIG. 9 is a flowchart for explaining a process for performing a lottery.

FIG. 10 is a diagram illustrating a configuration example of a computer.

### MODE FOR CARRYING OUT THE INVENTION

Embodiments to which the present technology is applied will be described hereinafter with reference to the drawings.

### First Embodiment

### <Configuration Example of Campaign System>

The present technology enables various lotteries to be performed by selecting user as member in advance and then determining a winning probability on the basis of at least attribute information indicating attributes of the users registered as the members or posting history information regarding a history of posting of receipt information or the like as purchase information by the users.

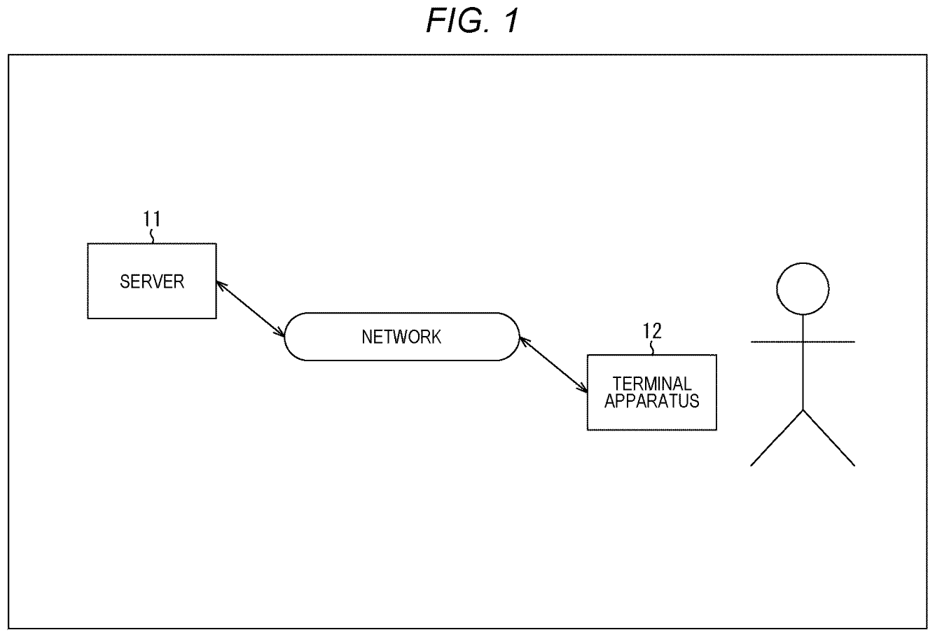

FIG. 1 is a diagram illustrating a configuration example of a campaign system to which the present technology is applied.

The campaign system illustrated in FIG. 1 includes a server 11 and a terminal apparatus 12, and the server 11 and the terminal apparatus 12 are connected to each other by a wired or wireless network.

The server 11 is, for example, an information processing apparatus that manages implementation of a campaign such as sales promotion provided by any service provider such as a pharmacy or a restaurant. The server 11 manages implementation of one or more campaigns.

By communicating with the terminal apparatus 12 over the network, the server 11 supplies display data regarding a web page related to a campaign to the terminal apparatus 12, registers users as members, and performs lottery processing of the campaign for which the users have applied.

The terminal apparatus 12 is an information processing apparatus such as a smartphone, a personal computer, or a tablet owned by a user participating in a campaign.

The terminal apparatus 12 communicates with the server 11 in accordance with operation of the user, requests member registration of the user, displays a web page related to a campaign, and transmits receipt information and the like necessary for a lottery to the server 11.

Note that here, only one user and the terminal apparatus 12 of the user are illustrated in order to simplify the description, but there is actually a plurality of users, and the terminal apparatus 12 of each of the users can access the server 11.

In the campaign system, the user performs member registration in advance for a website for providing a campaign managed by the server 11, that is, a campaign providing service for performing a lottery for a campaign.

In a case where the user obtains purchase information that is information regarding purchase of a service related to the campaign, such as a receipt obtained in a case where the user purchases a product at a store or the like that provides the campaign, the user participates in (applies for) the campaign, that is, the lottery of a premium, using the purchase information.

More specifically, the user operates the terminal apparatus 12 to post the purchase information to the server 11 in a state where the user has logged in to the web site (campaign providing service) of the server 11. That is, the purchase information is posted to the server 11 via the web.

Note that, in the following, a case where the purchase information is image data (hereinafter also referred to as receipt information) regarding a receipt obtained by capturing an image of the receipt will be described.

The present invention, however, is not limited to this, and the purchase information may be any information as long as the purchase information includes information regarding payment (settlement) of a price of a product or the like purchased by the user, that is, a service, the product, or the like provided for the user, and can prove the purchase by the user.

More specifically, for example, use records of electronic money, electronic receipt data, an electronic receipt, image data obtained through screen capture of electronic payment, or the like may be used as the purchase information.

In a case where the user posts receipt information, the server 11 immediately examines the posted receipt information. In the examination of the receipt information, it is determined whether or not the receipt information satisfies the application conditions of the campaign on the basis of the information regarding the purchase included in the posted receipt information.

In a case where it is determined that the application conditions are satisfied, the server 11 immediately performs lottery processing thereafter.

At this time, the server 11 determines a winning probability of the user on the basis of at least attribute information registered in advance indicating attributes of the user such as age and gender of the user or posting history information regarding a history of posting of receipt information by the user so far. In other words, the server 11 varies the winning probability of the user in accordance with the attribute information and the posting history information.

The server 11 then performs the lottery processing on the basis of the determined winning probability of the user, and transmits an electronic mail for notifying the user of a result of the lottery processing, that is, winning or losing.

Since the server 11 determines the winning probability and performs the lottery processing in a state where the user has logged in, the attributes and the posting history of the user can be used to determine the winning probability. As a result, it is possible to immediately perform various lotteries by changing (varying) a winning probability for each user in accordance with an intention of the campaign or the like.

Note that here, description will be given while assuming that a single server 11 performs the member registration of users, the examination of receipt information, the management of posting history information regarding receipt information, the lottery processing, and the like, but a plurality of servers may share and perform each of these types of processing, instead.

### <Configuration Example of Server>

Next, configuration examples of the server 11 and the terminal apparatus 12 will be described.

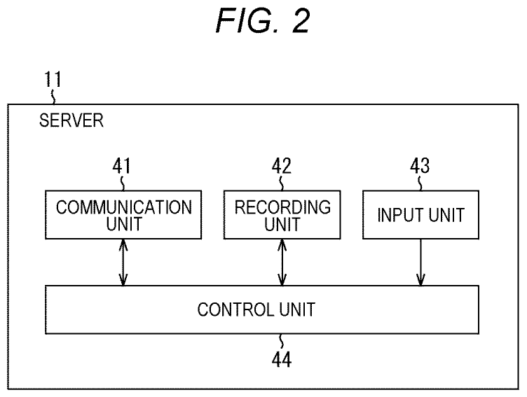

FIG. 2 is a diagram illustrating a configuration example of the server 11.

The server 11 includes a communication unit 41, a recording unit 42, an input unit 43, and a control unit 44.

The communication unit 41 communicates with an external apparatus such as the terminal apparatus 12 over the network. The recording unit 42 records various types of data supplied from the control unit 44, such as attribute information and posting history information, for example, and supplies the recorded data to the control unit 44 as necessary.

The input unit 43 includes a mouse, a keyboard, and the like, and supplies a signal corresponding to an operation performed by a manager or the like to the control unit 44. The control unit 44 controls the entire operation of the server 11.

### <Configuration Example of Terminal Apparatus>

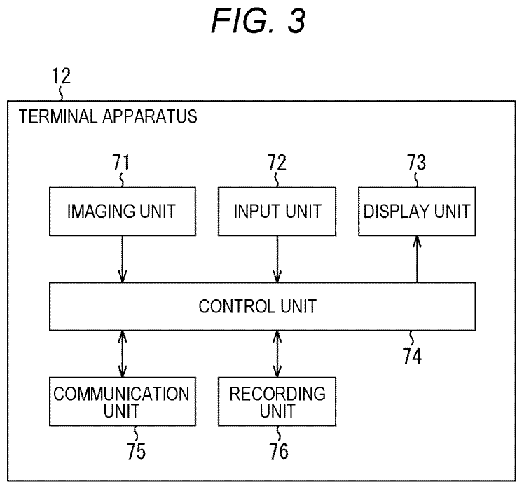

FIG. 3 is a diagram illustrating a configuration example of the terminal apparatus 12.

The terminal apparatus 12 includes an imaging unit 71, an input unit 72, a display unit 73, a control unit 74, a communication unit 75, and a recording unit 76.

The imaging unit 71 includes a camera, captures images of various subjects including a receipt under the control of the control unit 74, and supplies the captured image to the control unit 74.

The input unit 72 includes, for example, a touch panel, a button, or the like superimposed on the display unit 73, and supplies a signal corresponding to the user's operation to the control unit 74. The display unit 73 displays various images supplied from the control unit 74.

The control unit 74 controls the entire operation of the terminal apparatus 12. The communication unit 75 communicates with an external device such as the server 11 over the network.

The recording unit 76 records various types of data supplied from the control unit 74 and supplies recorded data to the control unit 74.

### <Member Registration>

The user performs member registration in advance in a case where the user uses the campaign providing service provided by the server 11.

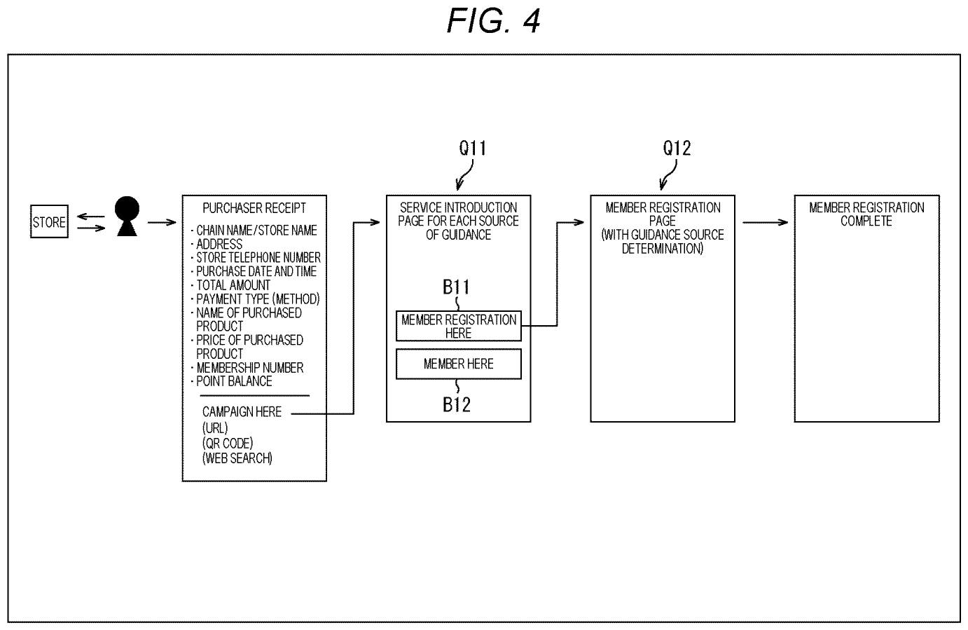

An example of the member registration will be described hereinafter with reference to FIG. 4.

As illustrated in a left side of FIG. 4, in a case where the user purchases a desired product at a store (hereinafter also referred to as a purchase store) that is conducting a campaign, the user receives a receipt from the store.

The receipt (purchase receipt) describes information regarding the store that has issued the receipt, information regarding the product purchased by the user, information regarding payment at a time of the purchase, and the like.

More specifically, for example, the receipt includes (describes) information such as a chain name and a store name of the store of purchase, an address of the store of purchase, a telephone number of the store of purchase, a date and a time of purchase, a total amount of payment, a payment type, a name of a purchased product, a price of the purchased product, a membership number of a member related to the store of purchase, the chain, or the like, and a point balance available at the store of purchase or the like. Here, the payment type is, for example, a method for paying a price of a purchased product, such as cash payment or electronic payment.

Furthermore, in this example, the receipt also includes information for accessing a web page dedicated to a campaign (hereinafter also referred to as a campaign dedicated page) that is being conducted by the store of purchase, the web page being managed by the server 11.

For example, the information for accessing the campaign dedicated page is a uniform resource locator (URL) of the campaign dedicated page, a quick response (QR) code (registered trademark) for obtaining the URL or the like, a keyword in a web search, or the like.

The user appropriately accesses the server 11 using the terminal apparatus 12 using the URL, the QR code (registered trademark), the keyword in a web search, or the like included in the receipt and displays the campaign dedicated page as indicated by an arrow Q11.

This campaign dedicated page is a web page (service introduction page) for each campaign conducted by the store of purchase or the chain to which the store of purchase belongs, the web page being introduced for the campaign, and is managed by the server 11. In other words, it can be said that the campaign dedicated page is a web page for each source of guidance (store of purchase) to the member registration.

For example, a button B11 on which a message such as “member registration here” is displayed and a button B12 on which a message such as “member here” is displayed are provided on the campaign dedicated page.

The button B11 is a button for displaying a member registration page for performing member registration of the user, and the button B12 is a button for displaying a login page for the user who has already registered as a member to log in.

For example, in a case where the user uses the button B11, a member registration page is displayed on the terminal apparatus 12 as indicated by an arrow Q12.

At this time, the server 11 can identify (determine) the campaign dedicated page from which the user has been guided to arrive at the member registration page, that is, the store of purchase or the chain that has served as the source of guidance to the member registration page. Information indicating a store of purchase or chain that has served as a source of guidance at a time of member registration will also be referred to as guidance source information hereinafter.

In a case where the member registration page is displayed, the user operates the terminal apparatus 12 to input information necessary for member registration, such as an account name, a password, a mail address, and gender.

The server 11 then generates member registration information regarding the user on the basis of the information input by the user, and performs the member registration of the user by recording the member registration information.

For example, the member registration information includes guidance source information, a mail address, gender, age, a residential area such as a prefecture, family make-up, an occupation, and the like.

In the information included in the member registration information, the user's gender, age, residential area, family make-up, occupation, and the like can be said to be attribute information indicating the user's own attributes. Note that the member registration information only needs to include at least one of the pieces of information indicating the attributes of the user, such as gender or age, and may include other pieces of information indicating attributes of the user.

In a case where the member registration information regarding the user is recorded (registered) in the recording unit 42 of the server 11, that is, a member database, the member registration of the user is completed, and a member registration completion page including a message indicating that the member registration has been completed is displayed on the terminal apparatus 12.

After the member registration is completed, the user can participate in (apply for) any campaign thereafter. That is, the user can participate in a plurality of any campaigns as much as possible by performing the member registration only once.

### <Description of Process for Requesting Member Registration and Process for Registering Member>

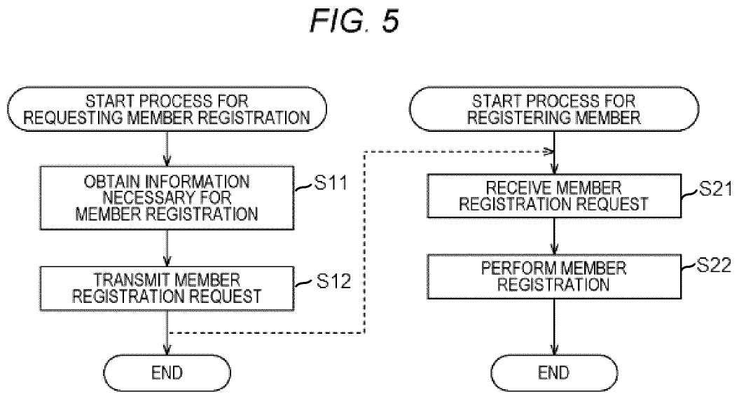

Here, a process performed at a time of the member registration of the user will be described with reference to FIG. 5. That is, the process for requesting member registration by the terminal apparatus 12 and the process for registering a member by the server 11 will be described hereinafter with reference to the flowchart of FIG. 5.

For example, in a case where the communication unit 75 of the terminal apparatus 12 receives the display data regarding a member registration page transmitted by the server 11 and the control unit 74 supplies the display data received by the communication unit 75 to the display unit 73 to display the member registration page, the process for requesting member registration is started.

In step S11, the control unit 74 obtains information necessary for the member registration of the user, such as attribute information.

That is, in a case where the user operates the input unit 72 to input the attribute information such as gender, age, and a residential area and information necessary for the member registration, such as a mail address and an account name, to the member registration page, the input unit 72 supplies a signal corresponding to the user's operation to the control unit 74.

The control unit 74 obtains information necessary for the member registration, such as the attribute information input by the user, by obtaining the signal from the input unit 72. The control unit 74 then generates a member registration request including the obtained information and requesting the member registration and supplies the member registration request to the communication unit 75.

In step S12, the communication unit 75 transmits the member registration request supplied from the control unit 74 to the server 11.

The server 11 then starts the process for registering a member and performs processing in step S21.

That is, in step S21, the communication unit 41 receives the member registration request transmitted from the terminal apparatus 12 and supplies the member registration request to the control unit 44.

In step S22, the control unit 44 performs the member registration in response to the member registration request supplied from the communication unit 41.

More specifically, the control unit 44 performs the member registration by generating member registration information including the attribute information and the mail address of the user included in the member registration request and supplying the generated member registration information to the recording unit 42 to record the member registration information.

At this time, the control unit 44 identifies a campaign dedicated page that has served on the terminal apparatus 12 as a source of guidance to the member registration page to identify (determine) the source of guidance at a time of the member registration, and generates member registration information including guidance source information indicating a result of the identification.

In a case where the member registration is completed, the control unit 44 supplies the display data regarding the member registration completion page to the communication unit 41 to transmit the display data to the terminal apparatus 12, and the process for registering a member ends.

Furthermore, in the terminal apparatus 12, too, after the processing in step S12 is completed, the communication unit 75 receives the display data from the server 11 and supplies the display data to the control unit 74, and the control unit 74 supplies the display data from the communication unit 75 to the display unit 73 to display the member registration completion page.

In a case where the member registration completion page is displayed in this manner and the user is notified of the completion of the member registration, the process for requesting member registration ends.

The terminal apparatus 12 thus obtains the information necessary for the member registration, such as the attribute information, and requests the member registration, and the server 11 performs the member registration in response to the member registration request.

In doing so, the user can participate in one or more campaigns at any timing after the member registration. Furthermore, at a time of lottery processing of the campaign, various lotteries can be immediately performed using the attribute information (member registration information) registered in advance.

### <Participation in Campaign>

In a case where the member registration is completed, the user logs in to the web site of the server 11, that is, the campaign providing service, selects a campaign to participate in, and participates in (applies for) the selected campaign.

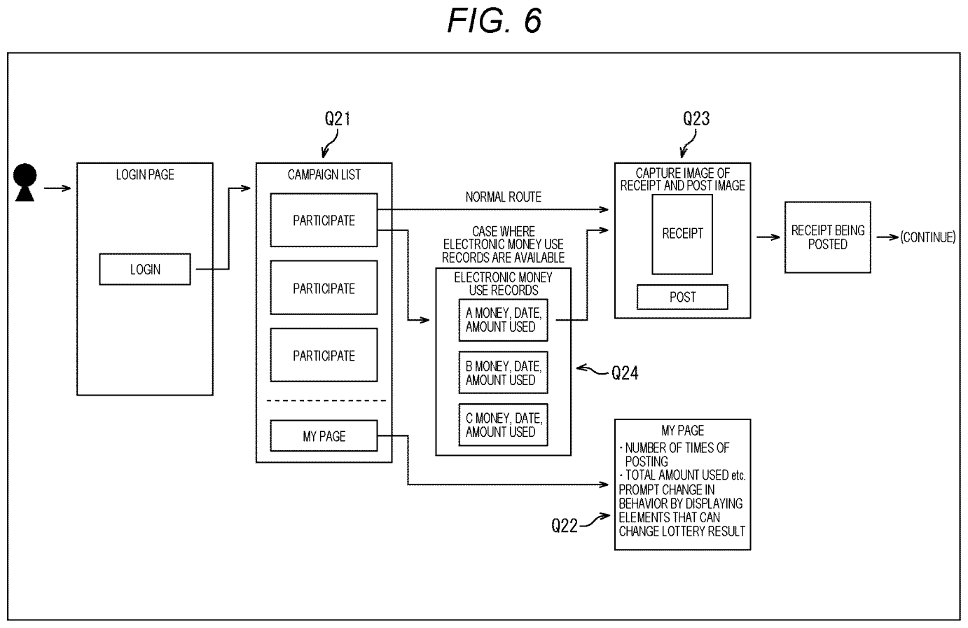

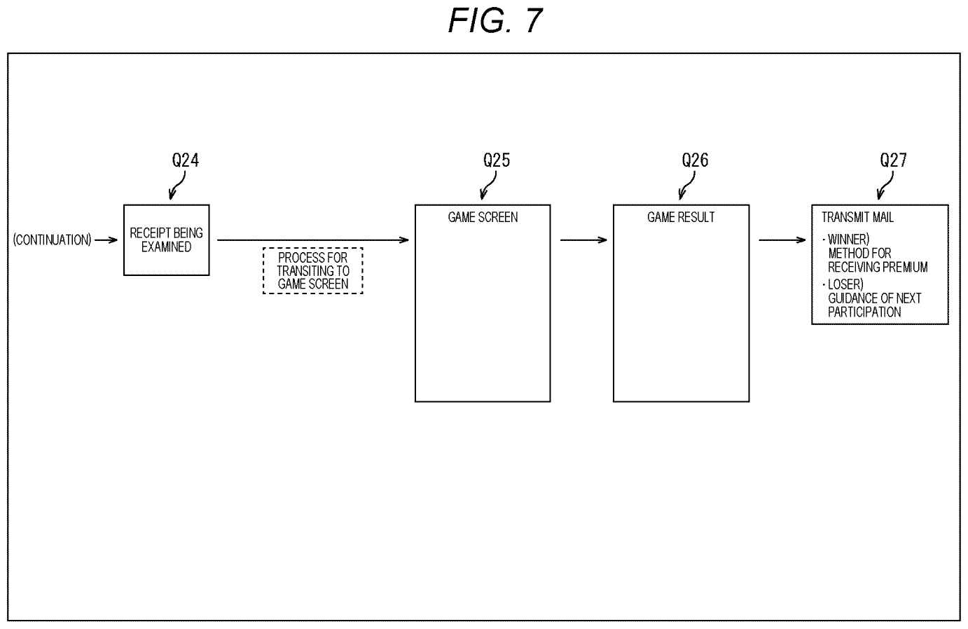

A procedure of a process in a case where the user participates in a campaign will be described hereinafter with reference to FIGS. 6 and 7. Note that FIG. 7 illustrates a continuation of the procedure of the process illustrated in FIG. 6.

As illustrated in a left side of FIG. 6, the user displays a login page on the terminal apparatus 12, and logs in by inputting an account name and a password.

The terminal apparatus 12 then displays a campaign list screen indicated by an arrow Q21.

The campaign list screen displays a My Page button for displaying My Page together with a list of campaigns that the user can participate in.

When the user uses the My Page button, My Page is displayed as indicated by an arrow Q22. In other words, the user can check their posting history of receipt information on a web screen by displaying My Page.

In My Page, information regarding the user's posting history (receipt posting history) of receipt information (purchase information), which is information regarding variation in the winning probability of the user, is displayed.

In other words, information regarding a posting history of receipt information such as the number of times the user has posted receipt information so far (the number of times of posting) and the total amount of money paid by the user for purchase, especially information that affects a lottery result of the user (elements related to variation in the winning probability), is displayed in My Page.

Furthermore, for example, in addition to the elements related to variation in the winning probability of the user, such as a message indicating that the winning probability doubles in a case where the total number of times of posting exceeds a certain number, the winning probability after the variation and the like may be presented (displayed) on My Page.

By displaying such My Page, it is possible to promote participation of the user in a campaign, that is, promote a change in the user's behavior.

Furthermore, in a case where the user selects a campaign in which the user participates from the campaign list screen, a posting screen of receipt information is displayed as indicated by an arrow Q23, and the user captures an image of a receipt necessary for participation in the campaign and posts the image. For example, the captured image of the receipt (receipt information) is displayed on the posting screen, and it is possible to check whether the receipt posted by the user is correct.

Note that in a case where receipt information, that is, an image of a receipt, is posted as purchase information, necessary information such as a payment type and a payment amount might not be accurately read from the receipt information.

Therefore, for example, as indicated by an arrow Q24, use records of electronic money may also be able to be posted together with the receipt information as the purchase information.

For example, the user can select whether to post only the receipt information or both the receipt information and the use records of electronic money. Furthermore, for example, posting of a use record of electronic money may be prompted in accordance with a result of an examination of the receipt information in the server 11.

In a case where the user posts a use record of electronic money, for example, the user operates the input unit 72 to display a list of use records of electronic money on the display unit 73 on the basis of the information or the like recorded in the recording unit 76.

For example, in the list of use records of electronic money, records in a case where the user have made payments using electronic money is displayed for each business operator such as a settlement service. The user selects information (use record information) indicating a use record of electronic money corresponding to receipt information to be posted from the list of use records, and posts the use record information regarding electronic money together with the receipt information.

As a result, the receipt information and the use record information regarding electronic money in a case where the user has made a payment (purchase) using electronic money are posted on the server 11.

The use recording information regarding electronic money includes some or all of a plurality of pieces of information included in the receipt information. That is, the use record information regarding electronic money includes, for example, information such as a purchase date and time and a total amount of payment.

By posting the use record information regarding electronic money together with the receipt information like this, even in a case where accuracy of reading information from the receipt information is not sufficient, it is possible to extract necessary information from the use record information regarding electronic money and examine the receipt information, that is, perform a determination as to the application conditions. That is, the use record information regarding electronic money can ensure the accuracy of reading information necessary for the examination of a payment type, a payment amount, and the like.

In a case where the receipt information is posted as described above, the server 11 examines the posted receipt information, for example, as indicated by an arrow Q24 in FIG. 7.

That is, the server 11 examines each of predetermined examination items on the basis of the information included in the posted receipt information to examine whether or not the receipt information satisfies the application conditions (participation conditions) of the campaign.

For example, the examination items may include a purchase date and time of a product or the like (a use date and time of a service), a chain used, a store used, an area (address) of the store used, purchase of a specific product, an amount paid for the purchase of the specific product, payment means (payment type), a total amount of payment, or the like.

For example, the area of the store used may be examined on the basis of the address of the store of purchase included in the receipt information, or may be examined on the basis of a telephone number of the store of purchase included in the receipt information. For example, in a case where the area is examined on the basis of the telephone number, the address of the shop of purchase need not be described in the receipt information.

Note that the examination items to be used for the examination are different for each campaign. Furthermore, the examination as to whether the application conditions are satisfied may be performed for each piece of posted receipt information, or may be performed on the basis of all pieces of receipt information posted during a campaign period. Therefore, for example, in a case where the sum of payment amounts in all pieces of receipt information posted during the campaign period is larger than or equal to a certain amount, it can be determined that the application conditions are satisfied. In this case, since the user need not post a plurality of pieces of receipt information together, convenience can be improved.

As a result of the examination, in a case where it is determined that the receipt information satisfies the application conditions, the server 11 updates the posting history information recorded in the recording unit 42 on the basis of the posted receipt information.

For example, the posting history information includes at least one of posting dates of receipt information, purchase dates of products or the like described in the receipt information, the number of times of posting of the receipt information, the total amount of payment in the posted receipt information, the number of times of posting of receipt information for each payment type, the total amount of payment for each payment type, the number of times of purchase of specific products, or the number of times of use of specific chains or stores.

Note that the posting history information only needs to include information regarding a posting history of receipt information to be used to determine a winning probability in a campaign, and may include any information such as, for example, presence or absence of posting of use record information regarding electronic money.

After the posting history information is updated, the server 11 performs a process for transiting to a game screen and causes the terminal apparatus 12 to display the game screen as indicated by an arrow Q25.

The game screen is, for example, a screen for playing a game of a lottery type, and the user appropriately uses a button or the like on the screen to play the game for a lottery. That is, in the server 11, a lottery based on a game of a lottery type is performed as the lottery processing based on a winning probability for each user.

The game of the lottery type may be any game as long as a lottery can be performed, such as a lottery based on a rotary lottery device called a lottery wheel or the like, a capsule toy, a slot machine, or a written fortune.

In providing the game of the lottery type, the server 11 determines the winning probability of the user on the basis of the member registration information regarding the user recorded in the recording unit 42, or more specifically at least the attribute information regarding the user included in the member registration information or the posting history information after update.

Furthermore, in a case where the user plays the game of the lottery type by performing an operation on the game screen or the like, the server 11 performs the lottery processing on the basis of the winning probability determined for the individual user.

In the determination of the winning probability of the user and the lottery processing, the server 11 refers not only to the attribute information and the posting history information but also to the campaign information recorded in the recording unit 42 as necessary.

The campaign information is information generated in advance for each campaign, and includes information regarding the campaign, such as an implementation period of the campaign (a period during which the campaign can be applied for), application conditions, the number of wins of each prize, and a reference winning probability of each prize.

As a method of determining a winning probability and performing a lottery, several methods are conceivable.

For example, a method in which a lottery is performed on the basis of each of items of a participation history of the user in campaigns, that is, the user's posting history of receipt information, a method in which a lottery is performed on the basis of each of items of the attributes of the user, a method in which a lottery is performed on the basis of each of items of a posting history of receipt information and attributes of the user, and the like are conceivable. Furthermore, for example, a method in which a lottery is performed without conditions, that is, a method in which a lottery is performed without considering attribute information and posting history information, is also conceivable.

As a specific example of a case where the posting history information is considered, for example, it is conceivable to set a winning probability of a user whose number of times of posting of receipt information is 10 or more to three times a reference probability, or set the winning probability to be 50% or more in a case where the total amount of payment in receipt information exceeds 10,000 yen. Furthermore, for example, it is also conceivable to set the winning probability such that 1 out of 10 people wins for a user who has use a specific chain more than 10 times.

Moreover, as a specific example of a case where the attribute information is considered, for example, it is conceivable to set a winning probability of a woman to 50%, set a winning probability of a man in his thirties or forties to 80%, or set a winning probability of a father or a mother in their twenties to 50%.

As described above, the server 11 can perform various lotteries in accordance with an intention of a campaign using the posting history information and the attribute information. In other words, it is possible to set an appropriate winning probability for each user in accordance with an intention of a campaign, and as a result, it is possible to achieve diversification of lottery methods.

After the server 11 performs the lottery processing, the terminal apparatus 12 displays a game result screen indicating a result of the lottery, that is, a result of a game of a lottery type, as indicated by an arrow Q26. In other words, the result of the lottery is presented (provided) to the user.

As indicated by an arrow Q27, the server 11 then appropriately transmits an electronic mail for notifying of the result of the lottery or the like.

For example, an electronic mail describing a fact of winning and a method for receiving a premium or the like is transmitted to a winner, and an electronic mail describing a fact of losing and guidance of participation in a next campaign or the like is transmitted to a loser.

As described above, in the campaign system, receipt information is examined immediately after being posted, and then the lottery processing is immediately performed in accordance with a result of the examination of the receipt information.

In particular, in the campaign system, various lotteries can be performed using the posting history information and the attribute information. Moreover, since the posting and examination of receipt information and the lottery processing are performed in a state where the user has logged in, it is possible to immediately read the posting history information and the attribute information regarding the user and perform the lottery processing.

### <Description of Process for Participating in Campaign>

Next, operations of the terminal apparatus 12 and the server 11 in a case where the user participates in a campaign will be described.

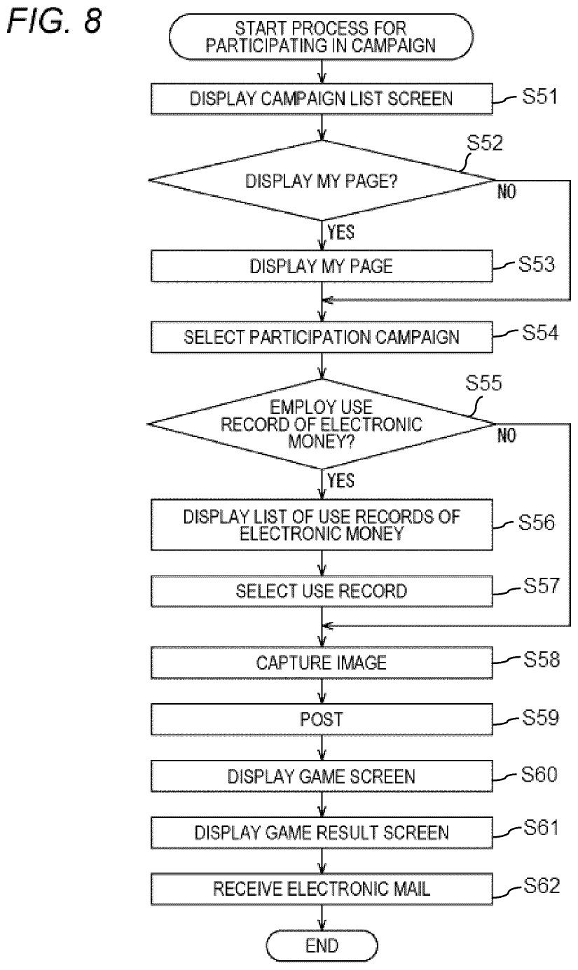

First, a process for participating in a campaign performed by the terminal apparatus 12 will be described with reference to a flowchart of FIG. 8. The process for participating in a campaign is started when the user logs in to the server 11 (campaign providing service).

In step S51, the control unit 74 causes the display unit 73 to display the campaign list screen.

For example, when the user logs in, the server 11 transmits display data regarding the campaign list screen the terminal apparatus 12, and the communication unit 75 receives the display data transmitted from the server 11 and supplies the display data to the control unit 74. The control unit 74 then supplies the display data from the communication unit 75 to the display unit 73, and the display unit 73 displays the campaign list screen on the basis of the supplied display data.

In step S52, the control unit 74 determines whether or not to display My Page on the basis of a signal supplied from the input unit 72 in accordance with the user's operation.

For example, when the user operates the input unit 72 to use the My Page button on the campaign list screen, it is determined that My Page is to be displayed.

If it is determined in step S52 that My Page is not to be displayed, processing in step S53 is not performed, and the process then proceeds to step S54. If it is determined in step S52 that My Page is to be displayed, on the other hand, the processing in step S53 is performed.

In this case, the control unit 74 generates a request to transmit display data regarding My Page and supplies the transmission request to the communication unit 75. When the communication unit 75 transmits the transmission request from the control unit 74 to the server 11, the display data is transmitted from the server 11 in response to the transmission request, and the communication unit 75 receives the display data from the server 11 and supplies the display data to the control unit 74.

In step S53, the control unit 74 supplies the display data supplied from the communication unit 75 to the display unit 73 to display My Page.

As described above, since information regarding the posting history of receipt information is displayed on My Page, the user checks their posting history of receipt information or the like by viewing My Page, and appropriately returns the display to the campaign list screen.

After the processing in step S53 is performed or if it is determined in step S52 that My Page is not to be displayed, processing in step S54 is then performed in a case where the user selects, from the campaign list screen, a campaign (hereinafter also referred to as a participation campaign) in which the user is to participate.

That is, in a case where the user operates the input unit 72 to select a desired campaign from a plurality of campaigns and determines to participate in the campaign, the control unit 74 selects, in step S54, the participation campaign selected by the user in accordance with a signal from the input unit 72.

Furthermore, in a case where the user posts use record information regarding electronic money together with the receipt information, the user requests display of the list of use records of electronic money by operating the input unit 72.

In step S55, the control unit 74 determines whether or not to employ a use record of electronic money, that is, whether or not to post use record information regarding electronic money, on the basis of a signal supplied from the input unit 72 in accordance with the user's operation.

In a case where it is determined in step S55 that a use record is not to be employed, processing in steps S56 and S57 is not performed, and the process then proceeds to step S58.

If it is determined in step S55 that a use record is to be employed, on the other hand, the process proceeds to step S56.

In step S56, the control unit 74 displays the list of use records of electronic money.

That is, the control unit 74 reads information regarding the user's use records of the electronic money from the recording unit 76 and generates display data for displaying the list of use records of electronic money on the basis of the read information. The control unit 74 then supplies the generated display data to the display unit 73 to display the list of use records of electronic money.

The user selects a use record of electronic money to be posted (used) as purchase information by operating the input unit 72 while viewing the list of use records of electronic money.

In step S57, the control unit 74 selects a use record of electronic money to be posted on the basis of a signal supplied from the input unit 72 in accordance with the user's operation, and generates and holds use record information regarding electronic money including content of the selected use record.

After the processing in step S57 is performed or if it is determined in step S55 that a use record is not to be employed, the imaging unit 71 captures an image of a receipt in step S58.

For example, the control unit 74 controls the imaging unit 71 in accordance with the user's operation appropriately performed at certain timing such as when the display unit 73 has displayed a receipt posting screen, and causes the imaging unit 71 to capture an image of a receipt to be posted as a subject. The imaging unit 71 captures an image under the control of the control unit 74 and supplies resultant image data to the control unit 74 as receipt information.

Note that here, an example in which the control unit 74 causes the imaging unit 71 to capture an image to obtain receipt information as purchase information is described. The present invention, however, is not limited to this, and the control unit 74 may obtain receipt information recorded in advance from the recording unit 76 or may obtain receipt information from an external apparatus.

When the receipt information is obtained, the control unit 74 generates an examination request that includes the obtained receipt information and that requests examination of the receipt information and supplies the examination request to the communication unit 75.

In this case, if the processing in step S57 has been performed and use record information regarding electronic money is held, the control unit 74 generates an examination request including not only the receipt information but also the use record information regarding electronic money.

In step S59, the communication unit 75 posts the receipt information specified by the user. That is, the communication unit 75 posts the receipt information by transmitting the examination request including at least the receipt information supplied from the control unit 74 to the server 11.

After the examination request is transmitted, the server 11 immediately examine the receipt information in response to the examination request and performs a game of a lottery type in accordance with a result of the examination.

That is, for example, if the server 11 determines that the receipt information satisfies the application conditions, the server 11 transmits display data regarding a game screen to the terminal apparatus 12, and the communication unit 75 receives the display data from the server 11 and supplies the display data to the control unit 74.

In step S60, the control unit 74 supplies the display data from the communication unit 75 to the display unit 73 to display the game screen.

In a case where the game screen is displayed, the user appropriately operates the input unit 72 to perform an operation, such as a start of the game, on the game screen. The control unit 74 makes a game start request or the like to the server 11 using the communication unit 75 on the basis of a signal from the input unit 72 in accordance with the user's operation.

The server 11 performs the lottery processing on the basis of the attribute information and the posting history information regarding the user in response to the request or the like from the terminal apparatus 12, and display data regarding a game result screen for notifying of a result of the lottery processing, that is, a game result, is transmitted from the server 11. The communication unit 75 receives the display data transmitted from the server 11 and supplies the display data to the control unit 74.

In step S61, the control unit 74 supplies the display data from the communication unit 75 to the display unit 73 to display the game result screen. This allows the user to know their result of the lottery.

Furthermore, the server 11 transmits an electronic mail corresponding to the result of the lottery to the user via a mail server or the like at any timing after the lottery.

In step S62, the communication unit 75 receives the electronic mail transmitted by the server 11 using the mail server or the like and supplies the electronic mail to the control unit 74. The control unit 74 supplies the electronic mail supplied from the communication unit 75 to the recording unit 76 to record the electronic mail or supplies the electronic mail to the display unit 73 to display the electronic mail. In a case where the game result screen is displayed and the electronic mail is received, the process for participating in a campaign ends.

As described above, the user posts receipt information and performs a game of a lottery type in accordance with a result of an examination based on the receipt information in a state where the user has logged in. In this case, since the user performs the member registration in advance and posts the receipt information in a state where the user has logged in, an immediate examination and an immediate lottery (game) can be performed.

### <Description of Process for Performing Lottery>

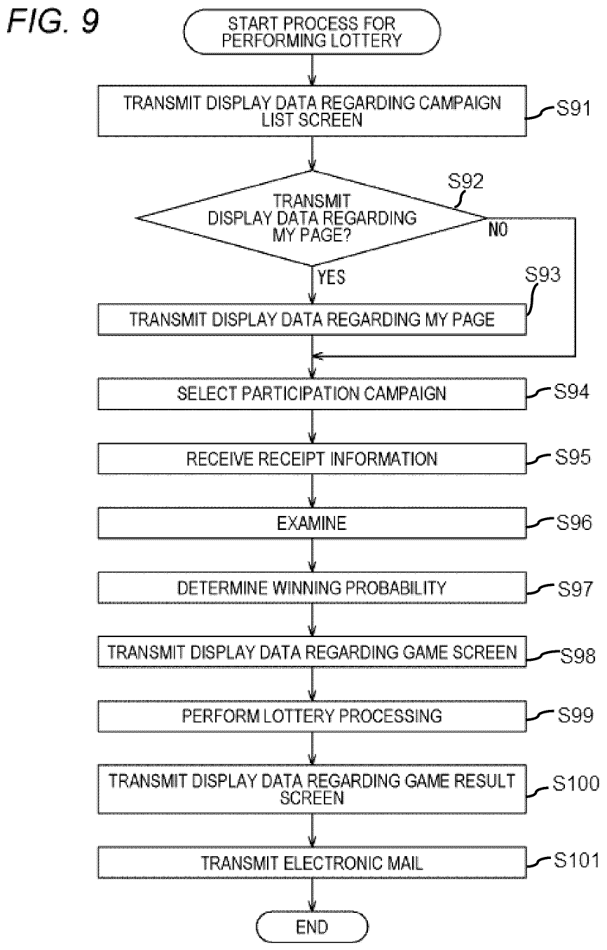

Furthermore, after the terminal apparatus 12 starts the process for participating in a campaign, that is, after a state where the user has logged in is established, the server 11 performs a process for performing a lottery illustrated in FIG. 9. The process for performing a lottery by the server 11 will be described hereinafter with reference to a flowchart of FIG. 9.

In step S91, the communication unit 41 transmits display data regarding the campaign list screen to the terminal apparatus 12.

For example, in a case where the user logs in, the control unit 44 generates display data regarding the campaign list screen on the basis of campaign information or the like recorded in the recording unit 42, and supplies the display data to the communication unit 41. The communication unit 41 then transmits the display data supplied from the control unit 44 to the terminal apparatus 12.

Furthermore, in a case where the My Page button on the campaign list screen is used in the terminal apparatus 12, the terminal apparatus 12 transmits a request to transmit display data regarding My Page to the server 11, and the communication unit 41 receives the transmission request and supplies the transmission request to the control unit 44.

In step S92, the control unit 44 determines whether or not to transmit the display data regarding My Page. For example, in step S92, in a case where the request to transmit the display data regarding My Page is received from the terminal apparatus 12, it is determined that the display data is to be transmitted.

If it is determined in step S92 that the display data regarding My Page is not to be transmitted, processing in step S93 is not performed, and the process then proceeds to step S94.

If it is determined in step S92 that the display data regarding My Page is to be transmitted, on the other hand, the process proceeds to step S93.

In this case, in response to the transmission request from the terminal apparatus 12, the control unit 44 generates the display data regarding My Page on the basis of the posting history information regarding the user and the campaign information recorded in the recording unit 42, and supplies the display data to the communication unit 41.

In step S93, the communication unit 41 transmits the display data regarding My Page supplied from the control unit 44 to the terminal apparatus 12. As a result, the terminal apparatus 12 displays My Page.

After the processing in step S93 is performed or if it is determined in step S92 that the display data is not to be transmitted, the processing in step S94 is then performed.

In step S94, the control unit 44 selects a participation campaign specified by the user.

For example, in a case where the user selects, on a terminal apparatus 12 side, a participation campaign from the campaign list screen, the terminal apparatus 12 appropriately notifies the control unit 44 of a result of the selection via the communication unit 41. The control unit 44 selects a participation campaign in accordance with the notification from the terminal apparatus 12, and transmits display data regarding the receipt posting screen or the like to the terminal apparatus 12 using the communication unit 41 as necessary. Through the following process, a lottery is performed for the campaign selected (specified) by the user from among a plurality of campaigns.

Furthermore, in a case where the user posts receipt information, the terminal apparatus 12 transmits an examination request including the receipt information to the server 11.

In step S95, the communication unit 41 receives the receipt information transmitted from the terminal apparatus 12, or more specifically, the examination request including the receipt information, and supplies the examination request to the control unit 44. In other words, the control unit 44 obtains the examination request including the receipt information from the terminal apparatus 12 via the communication unit 41 in a state where the user has logged in.

In step S96, the control unit 44 examines the receipt information in response to the examination request supplied from the communication unit 41. In particular, in this example, in a case where the examination request (receipt information) is received, the receipt information is immediately examined.

For example, the control unit 44 performs character recognition processing such as optical character recognition (OCR) on the receipt information included in the examination request to extract various pieces of information including a chain name, a store name, an address, and a telephone number of a store of purchase included in the receipt information.

Furthermore, in a case where the examination request includes use record information regarding electronic money, the control unit 44 appropriately uses a part or all of information included in the use record information, such as a purchase date and time, the total amount of payment, and a payment type, as information extracted (read) from the receipt information. At this time, the control unit 44 may collate the information extracted from the receipt information with the information included in the use record information regarding electronic money.

The control unit 44 examines each of examination items such as a purchase date and time and a chain used on the basis of each piece of information extracted from the receipt information while referring to the campaign information (application conditions) recorded in the recording unit 42 as appropriate. In other words, the control unit 44 examines whether or not the posted receipt information satisfies the application conditions.

After the receipt information is examined, the control unit 44 updates the posting history information regarding the user recorded in the recording unit 42 on the basis of the information extracted from the posted receipt information. Furthermore, if it is determined that the receipt information satisfies the application conditions, processing in step S97 is immediately performed thereafter.

That is, in step S97, the control unit 44 determines a winning probability of the user on the basis of at least the updated posting history information regarding the user recorded in the recording unit 42 or the attribute information included in the member registration information. In particular, in step S97, the winning probability is determined in a state where the user has logged in.

At this time, for example, the control unit 44 refers to information indicating an implementation period of the campaign included in the campaign information, and uses only receipt information posted by the user within the implementation period to determine the winning probability. In other words, the winning probability is determined using information regarding a posting history of receipt information in the implementation period of the campaign.

Furthermore, at the same time as determining the winning probability, the control unit 44 generates display data regarding the game screen, and supplies the display data to the communication unit 41.

In step S98, the communication unit 41 transmits the display data regarding the game screen supplied from the control unit 44 to the terminal apparatus 12.

Furthermore, after the terminal apparatus 12 displays the game screen and the user appropriately starts an operation such as a start of a game, the terminal apparatus 12 outputs a game start request or the like to the server 11.

In step S99, the control unit 44 performs lottery processing for the user on the basis of the winning probability determined in step S97 while appropriately referring to the campaign information and the like recorded in the recording unit 42 in response to the game start request or the like from the terminal apparatus 12.

Furthermore, after performing the lottery processing, the control unit 44 generates the display data regarding the game result screen on the basis of a result of the lottery processing, and supplies the display data to the communication unit 41.

In step S100, the communication unit 41 transmits the display data regarding the game result screen supplied from the control unit 44 to the terminal apparatus 12.

Moreover, after transmitting the display data regarding the game result screen, the control unit 44 generates an electronic mail corresponding to the result of the lottery processing to the user at any timing and supplies the electronic mail to the communication unit 41.

In step S101, the communication unit 41 transmits the electronic mail addressed to the user supplied from the control unit 44 to the mail server or the like, and the process for performing a lottery ends.

As described above, the server 11 immediately examines the receipt information and immediately performs the subsequent lottery processing. In particular, the server 11 can immediately perform various lotteries by performing the lottery processing using the posting history information and the attribute information in a state where the user logged in.

Note that although an example in which a single server 11 examines the receipt information, updates the posting history information, and performs the lottery processing has been described in the process for performing a lottery of FIG. 9, a plurality of servers may share and perform each of these types of processing, instead. Furthermore, the process for registering a member described with reference to FIG. 5 may also be performed by a server other than the server 11, instead.

In this case, for example, the member registration information and the posting history information can be recorded in the server other than the server 11 and supplied to the server 11 as necessary.

### <Configuration Example of Computer>

Note that the series of processes described above may be executed by hardware or software. In a case where the series of processes is executed by software, a program constituting the software is installed in a computer. Here, the computer includes a computer incorporated in dedicated hardware, a general-purpose computer for example that can execute various functions by installing various programs, and the like.

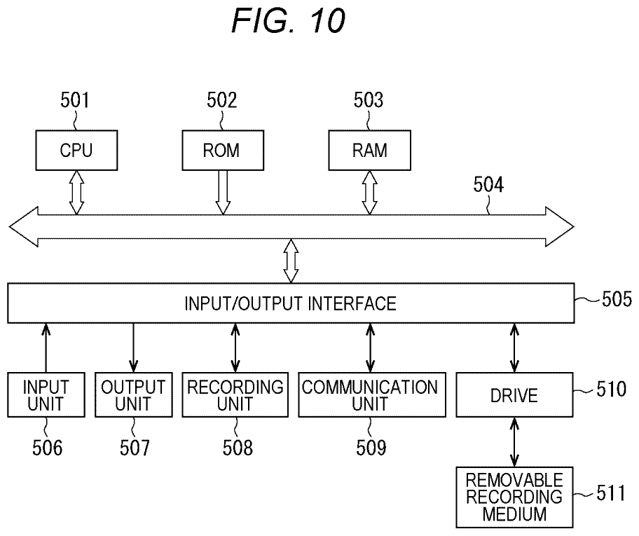

FIG. 10 is a block diagram illustrating a configuration example of hardware of a computer that executes the above-described series of processing using a program.

In the computer, a central processing unit (CPU) 501, a read-only memory (ROM) 502, and a random-access memory (RAM) 503 are connected to one another by a bus 504.

An input/output interface 505 is also connected to the bus 504. An input unit 506, an output unit 507, a recording unit 508, a communication unit 509, and a drive 510 are connected to the input/output interface 505.

The input unit 506 includes a keyboard, a mouse, a microphone, an imaging device, and the like. The output unit 507 includes a display, a speaker, and the like. The recording unit 508 includes a hard disk, a non-volatile memory, and the like. The communication unit 509 includes a network interface and the like. The drive 510 drives a removable recording medium 511 such as a magnetic disk, an optical disk, a magneto-optical disk, or a semiconductor memory.

In the computer configured as described above, the CPU 501 loads, for example, a program recorded in the recording unit 508 into the RAM 503 via the input/output interface 505 and the bus 504, and executes the program to perform the series of processes described above.

The program executed by the computer (CPU 501) can be provided by being recorded on the removable recording medium 511 as a package medium and the like, for example. Further, the program can be provided via a wired or wireless transmission medium such as a local area network, the Internet, or digital satellite broadcasting.

In the computer, the program can be installed in the recording unit 508 via the input/output interface 505 by mounting the removable recording medium 511 on the drive 510. Furthermore, the program can be received by the communication unit 509 via the wired or wireless transmission medium to be installed on the recording unit 508. In addition, the program can be installed in the ROM 502 or the recording unit 508 in advance.

Note that the program executed by the computer may be a program in which processing is performed in time series in the order described in the present specification or may be a program in which processing is performed in parallel or at necessary timing such as when a call is made.

Furthermore, the embodiments of the present technology are not limited to the above-described embodiments, and various modifications are possible without departing from the scope of the present technology.

For example, the present technology can have a cloud computing configuration in which one function is shared and processed in cooperation by a plurality of devices via a network.

Furthermore, each step described in the above-described flowchart can be executed by one device, and also shared and executed by a plurality of devices.

Moreover, in a case where one step includes a plurality of processes, the plurality of processes included in the one step can be executed by one device, and also shared and executed by a plurality of devices.

Moreover, the present technology may also have following configurations.

(1)

An information processing apparatus including:
a control unit that determines a winning probability of a user on the basis of at least attribute information indicating an attribute of the user registered in advance or posting history information regarding a history of posting of purchase information by the user and that performs lottery processing on the basis of the winning probability.
   (2)

The information processing apparatus according to (1), in which
the control unit determines the winning probability in a state where the user has logged in and performs the lottery processing.
   (3)

The information processing apparatus according to (1) or (2), in which
the control unit generates display data for displaying My Page, which includes information regarding the history of posting of the purchase information by the user and variation in the winning probability of the user, on the basis of the posting history information,
the information processing apparatus further including:
a communication unit that transmits the display data to a terminal apparatus of the user.
   (4)

The information processing apparatus according to any one of (1) to (3), in which
the control unit performs the lottery processing on a campaign selected by the user from among a plurality of Campaigns.
   (5)

The information processing apparatus according to any one of (1) to (4), in which
the attribute information includes at least one of gender, age, a residential area, family make-up, or an occupation of the user.
   (6)

The information processing apparatus according to any one of (1) to (5), in which
the posting history information includes at least one of a posting date of the purchase information, a purchase date, a number of times of posting, a total amount of payment, a number of times of posting for each payment type, a total amount of payment for each payment type, a number of times of purchase of a specific product, or a number of times of use of a specific chain or a specific store.
   (7)

The information processing apparatus according to any one of (1) to (6), in which
the control unit obtains, in a state where the user has logged in, the purchase information posted by the user, examines whether or not the purchase information satisfies an application condition, and, in a case where the purchase information satisfies the application condition, determines the winning probability and performs the lottery processing.
   (8)

The information processing apparatus according to (7), in which
the control unit obtains receipt information and use record information regarding electronic money as the purchase information.
   (9)

The information processing apparatus according to any one of (1) to (8), in which
the control unit performs a lottery based on a game of a lottery type as the lottery processing.
   (10)

The information processing apparatus according to (9), in which
the game of the lottery type is a capsule toy.
   (11)

An information processing method including:
determining, using an information processing apparatus, a winning probability of a user on the basis of at least attribute information indicating an attribute of the user registered in advance or posting history information regarding a history of posting of purchase information by the user and performing lottery processing on the basis of the winning probability.
   (12)

A program causing a computer to perform a process including:
determining a winning probability of a user on the basis of at least attribute information indicating an attribute of the user registered in advance or posting history information regarding a history of posting of purchase information by the user and performing lottery processing on the basis of the winning probability.

### REFERENCE SIGNS LIST

11 Server
12 Terminal apparatus
41 Communication unit
42 Recording unit
43 Input unit
44 Control unit

What is claimed is:

1. An information processing apparatus comprising:
a control unit that determines a winning probability of a user on a basis of at least attribute information indicating an attribute of the user registered in advance or posting history information regarding a history of posting of purchase information by the user and that performs lottery processing on a basis of the winning probability.

2. The information processing apparatus according to claim 1, wherein
the control unit determines the winning probability in a state where the user has logged in and performs the lottery processing.

3. The information processing apparatus according to claim 1, wherein
the control unit generates display data for displaying My Page, which includes information regarding the history of posting of the purchase information by the user and variation in the winning probability of the user, on a basis of the posting history information,
the information processing apparatus further comprising:
a communication unit that transmits the display data to a terminal apparatus of the user.

4. The information processing apparatus according to claim 1, wherein
the control unit performs the lottery processing on a campaign selected by the user from among a plurality of campaigns.

5. The information processing apparatus according to claim 1, wherein
the attribute information includes at least one of gender, age, a residential area, family make-up, or an occupation of the user.

6. The information processing apparatus according to claim 1, wherein
the posting history information includes at least one of a posting date of the purchase information, a purchase date, a number of times of posting, a total amount of payment, a number of times of posting for each payment type, a total amount of payment for each payment type, a number of times of purchase of a specific product, or a number of times of use of a specific chain or a specific store.

7. The information processing apparatus according to claim 1, wherein
the control unit obtains, in a state where the user has logged in, the purchase information posted by the user, examines whether or not the purchase information satisfies an application condition, and, in a case where the purchase information satisfies the application condition, determines the winning probability and performs the lottery processing.

8. The information processing apparatus according to claim 7, wherein
the control unit obtains receipt information and use record information regarding electronic money as the purchase information.

9. The information processing apparatus according to claim 1, wherein
the control unit performs a lottery based on a game of a lottery type as the lottery processing.

10. The information processing apparatus according to claim 9, wherein
the game of the lottery type is a capsule toy.

11. An information processing method comprising:
determining, using an information processing apparatus, a winning probability of a user on a basis of at least attribute information indicating an attribute of the user registered in advance or posting history information regarding a history of posting of purchase information by the user and performing lottery processing on a basis of the winning probability.

12. A program causing a computer to perform a process comprising:
determining a winning probability of a user on a basis of at least attribute information indicating an attribute of the user registered in advance or posting history information regarding a history of posting of purchase information by the user and performing lottery processing on a basis of the winning probability.
